(19) United States
(12) Patent Application Publication
(10) Pub. No.: US 2008/0016713 A1
(43) Pub. Date: Jan. 24, 2008

(54) APPARATUS, SYSTEM AND METHOD FOR PROCESSING A SUBSTRATE THAT PROHIBITS AIR FLOW CONTAINING CONTAMINANTS AND/OR RESIDUES FROM DEPOSITING ON THE SUBSTRATE

(76) Inventor: Zhi Lewis Liu, Paoli, PA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/777,258

(22) Filed: Jul. 12, 2007

Related U.S. Application Data
(60) Provisional application No. 60/830,223, filed on Jul. 12, 2006.

(51) Int. Cl. F26B 5/08; B08B 3/00

(52) U.S. Cl. 34/312; 134/1.3; 134/33; 34/307

(57) ABSTRACT

A method and system for preventing the deposit of residues on a substrate. Aspects of the system are modified in order to prevent the deposit of residue of substrates. In particular, gaps located within the system between the splash guard and the process chamber wall are closed, minimized and/or given a non-linear shape so as to prevent the deposit of materials back onto the substrate. In one aspect, the invention is a system for processing a substrate comprising: a rotary support for supporting a substrate in a substantially horizontal orientation, the rotary support adapted to rotate about an axis of rotation; a wall circumferentially surrounding the rotary support about the axis of rotation, the wall extending above and below a top surface of a substrate positioned on the rotary support; a splash guard circumferentially surrounding the rotary support about the axis of rotation, the splash guard positioned between the rotary support and the wall so that an annular gap exists between an outer surface of the splash guard and an inner surface of the wall structure; a structure extending upward from the outer surface of the splash guard, the structure adapted to prohibit droplets carried upward through the gap by air flow from depositing on a substrate on the rotary support.

### CROSS-REFERENCE TO RELATED PATENT APPLICATIONS

The present application claims the benefit of U.S. Provisional Patent Application No. 60/830,223, filed Jul. 12, 2006, the entirety of which is hereby incorporated by reference.

### FIELD OF THE INVENTION

The present invention relates generally to the field of processing substrates that require high levels of cleanliness, and specifically to apparatus, systems and methods for processing semiconductor wafers that prevent the deposit of contaminant and/or residues carried by air flow.

### BACKGROUND OF THE INVENTION

In the field of semiconductor manufacturing, it has been recognized since the beginning of the industry that maintaining the semiconductor wafers free of contaminants, including particles and residues, during the manufacturing process is a critical requirement to producing quality profitable wafers. There are many methods and systems for cleaning semiconductor wafers. As the size of semiconductor wafers continues to increase and the devices continue to become more and more miniaturized, the number of semiconductor devices present on a single wafer continues to exponentially grow. As a result, the trend in the industry has been to move to single-wafer processors for more and more processing steps, including cleaning and drying.

An example of a single-wafer cleaning system that utilizes megasonic energy is disclosed in U.S. Pat. No. 6,039,059 (“Gran”), issued Mar. 21, 2000. An example of a single-wafer cleaner and dryer is disclosed in U.S. Pat. No. 7,100,304 (“Lauerhaas et al.”), issued Sep. 5, 2006. The entireties of Bran and Lauerhaas et al. are hereby incorporated by reference.

In single-wafer processing systems, such as the ones mentioned above, a semiconductor wafer is supported and rotated in horizontal orientation. A desired processing chemical is then applied to one or both sides/surfaces of the wafer. Typically, at the end of the processing chemical application step, the wafer is rotated at a high RPM so that centrifugal forces fling the remaining chemicals from the edges of the substrate. The wafer surface may also be rinsed at remaining chemicals from the edges of the substrate. The wafer surface may also be rinsed at this time. As discussed above, it is important that the level of contaminants and/or residues left on the surface of the wafer be minimized to the extent possible at all times.

Because space in clean rooms is extremely valuable and scarce, single-wafer processors, such as the Lauerhaas system, are designed to take up as little as space as possible. Thus, the structure that surround the perimeter of wafers in order to contain chemicals that are flung off the wafer during processing are typically not much larger than the wafer itself. Referring to FIGS. 1-3, the containment structure of the Lauerhaas system 100 is in the form of a process bowl 106. While the process bowl 106 of the Lauerhaas system 100 serves the vital function of containing potentially hazardous chemicals, it also presents a problem in that the chemicals and contaminants being flung off the wafer 114 during the spinning process can contact the inner wall of the process bowl 106 and splash back onto the wafer surface, thereby re-contaminating the wafer 114 and causing semiconductor device failure problems.

In order to remedy this splash back problem, existing single-wafer systems utilize a splash guard to prevent the chemicals from splashing back onto the wafer. Referring still to FIGS. 1-3, in the Lauerhaas system 100, a vertically retractable splash guard 134 is utilized. The splash guard 134 cicumferentially surrounds the edge of the wafer 114 and has an angled portion 212 that deflects chemicals being flung off the 114 downward and away from the wafer 114. However, the Lauerhaas system 100 has been discovered to be susceptible to splash back related issues when used to perform certain processes.

One of the methods used for cleaning semiconductor wafers uses dilute sulfuric peroxide (H₂SO₄+H₂O₂+HF), which is commonly referred to in the art as DSP cleaning. DSP cleaning involves a mixture of dilute sulfuric acid and hydrogen peroxide. It has been discovered that when using DSP cleaning, sulfur residues can remain on the surface of the substrate after the cleaning is cycle is complete. For obvious reasons, the presence of any residue and/or contaminant is not beneficial. It is believed that the sulfur residue comes from the DSP chemical.

In order to come up with a solution to the residue problem, a DSP cleaning process was conducted in a single-wafer system similar to the one disclosed in Lauerhaas et al. At the end of the DSP cleaning cycle, many liquid droplets were observed on the inside of the cleaning chamber (i.e., on both the splash guard and the process bowl) after the DSP cleaning. These droplets were tested and discovered to contain sulfuric acid (H₂SO₄). Sulfuric acid is typically harder to be rinsed off a surface by DI water than other processing chemicals because sulfuric acid has a higher density than DI water and has a tendency to accumulate together.

It was also observed that the substrates subjected to the DSP cleaning process were contaminated with residue marks and droplets. The residue/contaminant on the substrates was determined to be sulfur residue by chemical analysis. The sulfur residue was deposited randomly at various locations on the substrates and the problem was observed in at least 1 out of 25 substrates processed. The size of residue particulates ranged in size from 6 to 20 mm². Each time, many liquid droplets were observed on the inside cleaning chamber (on both the splash guard and the bowl).

FIGS. 4A and 4B are particle maps of the substrates showing the sulfur residue contamination. The substrates 10 are shown with sulfur residue/particles 8 located randomly on the substrates 10. The sulfur residue particles 8 were measured from 0.13 μm and above with 3 mm edge exclusion. FIG. 5 is a table of the sulfur residue/particle data detected by a KLA Tencor SP1™ on the substrates. The shaded areas on the table represent substrates 10 that were contaminated with sulfur residue/particles 8.

Several sources and reasons for sulfur residue contamination were developed and considered. FIG. 6 schematically illustrates the system used and the mechanism discovered by the current inventor which is believed to result in the creation of the sulfur residue 8 on the substrates 10. Stated simply, the sulfur residue 8 on the substrate 10 is believed to be caused by sulfur droplets 11 splashed back during the 1200 rpm spinning of the substrate 10 that occurs after an IPA based drying step, despite the presence of a splash guard 12. As discussed above, many sulfur droplets were discovered in the chamber 15, including on the process bowl 14, the splash guard 12, the backside nozzle 20 and the inner surfaces of rotary chuck 22. For ease of illustration and discussion, only a partial section of the process bowl 14 and the splash guard 12 are illustrated. Of course, the process bowl 14 and splash guard 12 circumferentially surround the substrate 10.

A plurality of posts 26 are located proximate to the peripheral edge of substrate 10 and keep the substrate 10 in place during rotation. It is believed that droplets of sulfur 11 are vibrated off and dropped on the chuck 22 due to the high speed spinning of substrate 10. All of the droplets inside and adhering to the chuck 22 spin at 1200 rpm along with chuck 22. These droplets 11 are believed to be flung out radially from substrate 10 and the chuck 22 due to strong centrifugal force. The flying droplets 11 travel through holes 24 at the bottom of the chuck 22 (located below splash guard 12) and crash into the process bowl 14. This results in more droplets 11 flying in all directions. It has been discovered that some of the splashed droplets 11 are carried upward between the outer surface of the splash guard 12 and the inner surface of the process bowl 14, through the gap 17 at edge seal 16, and are deposited back on substrate 10 by the pattern of the air flow. The path/movement of the droplets are indicated by the arrows.

Splash-back from the splash guard 12 itself is also believed to happen as well. However, such flying droplets are believed to be very small because few droplets remain on the substrate 10 after the IPA base drying. Such small splash-back droplets are believed to not be able to reach the substrate 10 due to distance the particles would have to travel.

Therefore there is a need to provide an improved apparatus, system and method for processing substrates that prevents and/or minimizes the deposit of residues and/or contaminants on the substrate.

### SUMMARY OF THE INVENTION

The aforementioned and other deficiencies are remedied by the present invention which is an improved apparatus, system and method for processing substrates that prevents the deposit of particles on their surface.

In one aspect, the invention can be a system for processing a substrate comprising: a rotary support for supporting a substrate in a substantially horizontal orientation, the rotary support adapted to rotate about an axis of rotation; a wall structure circumferentially surrounding the rotary support about the axis of rotation, the wall structure extending above and below a top surface of a substrate positioned on the rotary support; a splash guard circumferentially surrounding the rotary support about the axis of rotation, the splash guard positioned between the rotary support and the wall structure so that an annular gap exists between an outer surface of the splash guard and an inner surface of the wall structure; means for moving the splash guard between a processing position and a retracted position; and a member extending from the wall structure to the outer surface of the splash guard when the splash guard is in the processing position, the member adapted to allow unimpeded movement of the splash guard between the retracted position and the process position.

In another aspect, the invention can be a system for processing a substrate comprising: a rotary support for supporting a substrate in a substantially horizontal orientation, the rotary support adapted to rotate about an axis of rotation; a wall structure circumferentially surrounding the rotary support about the axis of rotation, the wall structure extending above and below a top surface of a substrate positioned on the rotary support; a splash guard circumferentially surrounding the rotary support about the axis of rotation, the splash guard positioned between the rotary support and the wall structure so that an annular gap exists between an outer surface of the splash guard and an inner surface of the wall structure; means for vertically moving the splash guard between a processing position and a retracted position; an edge seal connected to the inner surface of the wall structure; and wherein when the splash guard is in the processing position, the edge seal contacts an outer surface of the splash guard thereby substantially enclosing the gap.

In yet another aspect, the invention can be a system for processing a substrate comprising: a rotary support for supporting a substrate in a substantially horizontal orientation, the rotary support adapted to rotate about an axis of rotation; a wall circumferentially surrounding the rotary support about the axis of rotation, the wall extending above and below a top surface of a substrate positioned on the rotary support; a splash guard circumferentially surrounding the rotary support about the axis of rotation, the splash guard positioned between the rotary support and the wall so that an annular gap exists between an outer surface of the splash guard and an inner surface of the wall structure; a structure extending upward from the outer surface of the splash guard, the structure adapted to prohibit droplets carried upward through the gap by air flow from depositing on a substrate on the rotary support.

In still another aspect, the invention can include a transducer assembly comprising a transmitter and a transducer acoustically coupled to the transmitter.

In other aspects, the invention can be methods of processing substrates using the aforementioned systems.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view of a prior art single-wafer processor.

FIG. 2 is a perspective view of the prior art single-wafer processor FIG. 1 with a wafer supported therein.

FIG. 3 is a schematic of how the splash guard of the prior art single-wafer process or FIG. 1 deflected chemicals downward.

FIG. 4A is a first particle map of a substrate showing particulate residue when processed by a system similar to the prior art single-wafer processor of FIG. 1.

FIG. 4B is a second particle map of a substrate showing particulate residue when processed by a system similar to the prior art single-wafer processor of FIG. 1.

FIG. 5 is a chart of cleaning results including particle data and residue on substrates cleaned on a system similar to the prior art single-water processor of FIG. 1.

FIG. 6 is a schematic illustrating the path of sulfur droplets back onto substrates processed in a system similar to the prior art single-wafer processor of FIG. 1.

FIG. 7A is a diagram showing a cleaning system according to an embodiment of the present invention with a first embodiment of a deflecting mechanism.

FIG. 7B is a diagram showing a cleaning system according to an embodiment of the present invention with a second embodiment of a deflecting mechanism.

FIG. 7C is a diagram showing a cleaning system according to an embodiment of the present invention with a third embodiment of a deflecting mechanism.

FIG. 8 is a schematic of a system according to an embodiment of the invention illustrating how the first embodiment of the deflecting mechanism prevents residue from being deposited on a substrate.

FIG. 9 is a chart of cleaning results from using the system of the present invention according to the first embodiment.

FIG. 10A is a top schematic view of a substrate cleaning system according to an embodiment of the present invention illustrating a fourth embodiment of the deflecting mechanism.

FIG. 10B is a side view of the substrate cleaning system of FIG. 10A illustrating the flow of sulfur droplets traveling through the system.

FIG. 11A is a side view of a substrate cleaning system according to an embodiment of the present invention illustrating a fifth embodiment of the deflecting mechanism.

FIG. 11B is a top schematic view of the substrate cleaning system of FIG. 11A.

FIG. 12 is a top view of a substrate cleaning system according to an embodiment of the present invention.

FIG. 13 is an isometric top view of a deflector according to an embodiment of the present invention when viewed from the rear.

FIG. 14A is a schematic illustrating residue deposits caused by X-Y movement of the substrate with respect to the rotary support.

FIG. 14B is a schematic illustrating residue deposits caused by relative rotational movement between the rotary support and the substrate.

FIG. 15 is schematic illustrating additional areas where measures can be taken in order to prevent residue deposits.

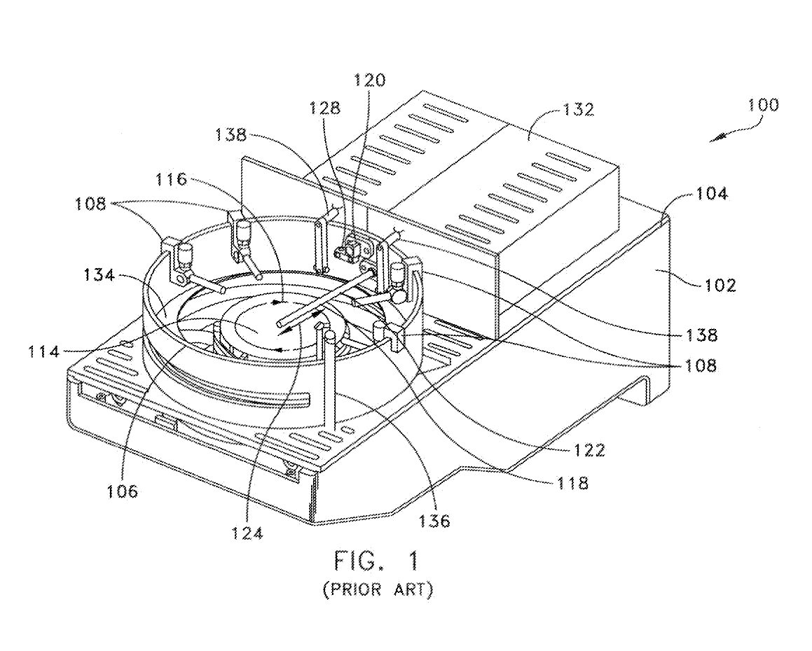

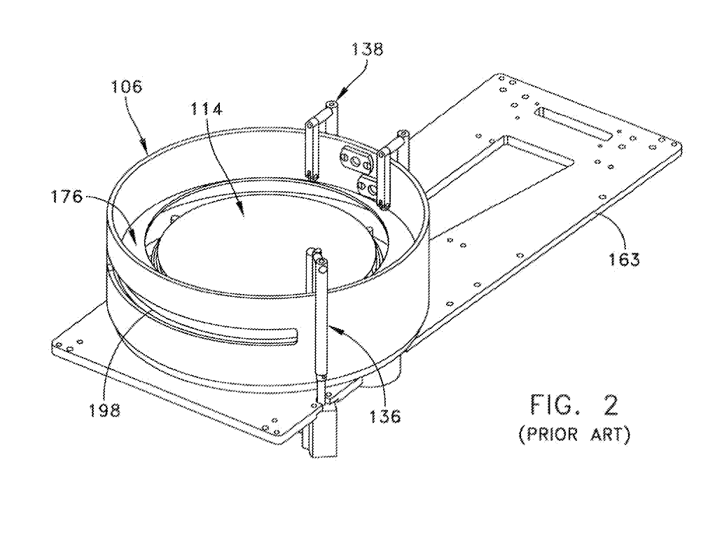

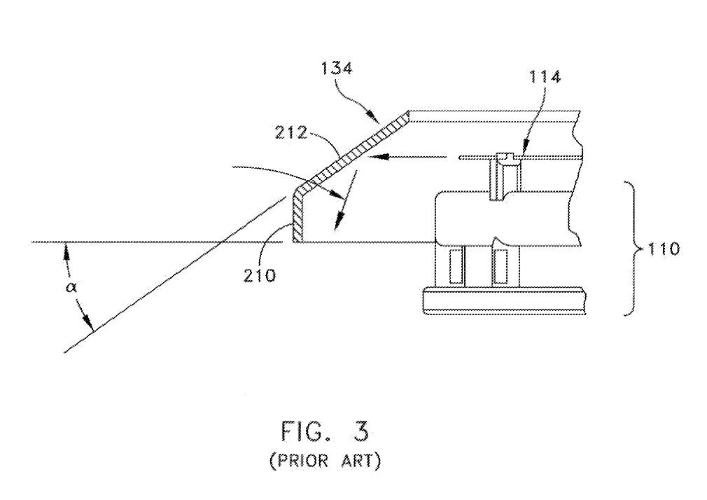

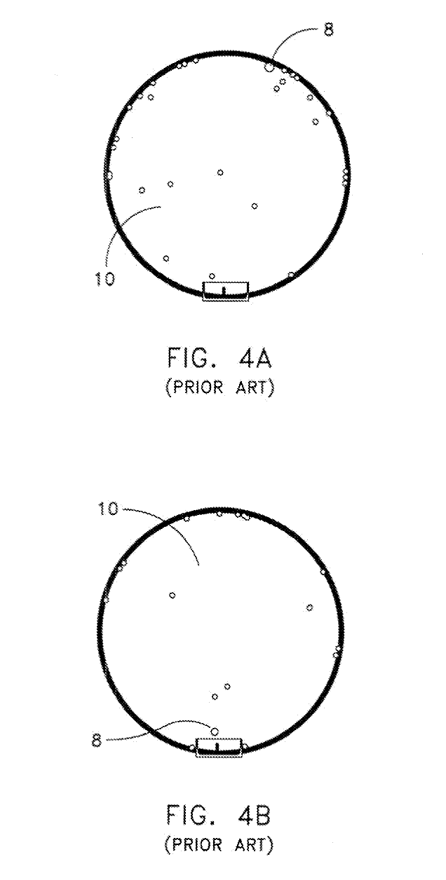

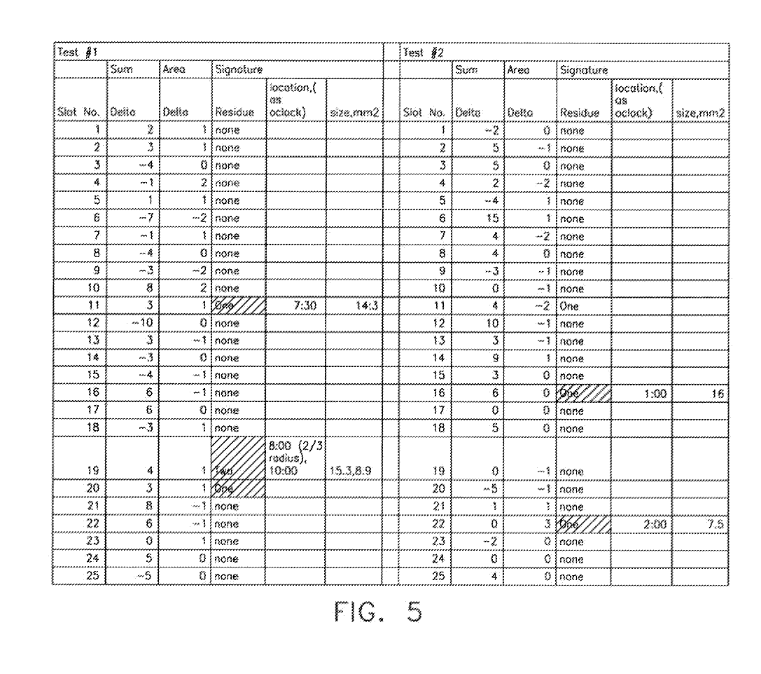

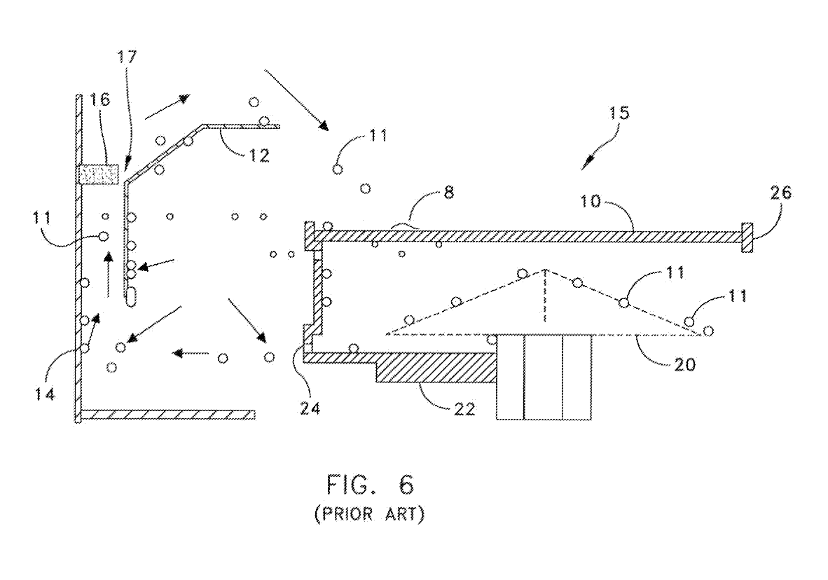

### DETAILED DESCRIPTION OF THE DRAWINGS

The instant invention provides a method and system for preventing contamination of substrates with residues and/or contaminants, such as the sulfur residues discussed above.

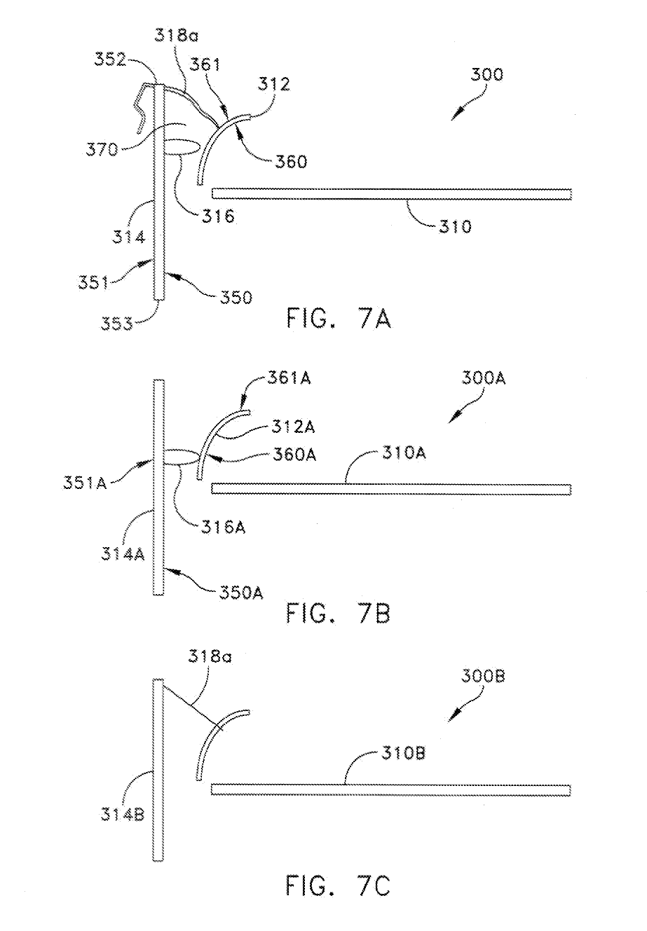

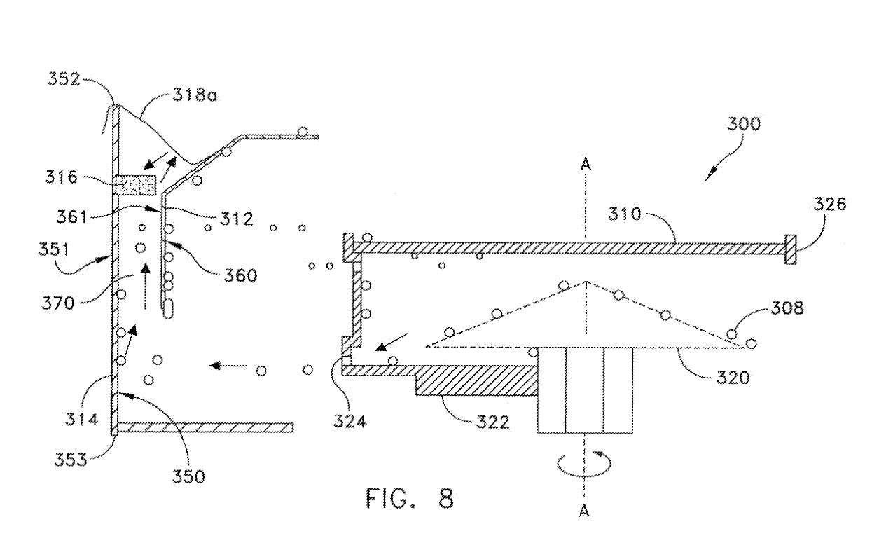

Referring to FIGS. 7a and 8 concurrently, a schematic of single-wafer cleaning and drying system 300 according to one embodiment of the present invention is illustrated. With the exception of the modification discussed below, the single-wafer cleaning system 300 is identical to the megasonic cleaning and drying system disclosed in U.S. Pat. No. 7,100,304 (“Lauerhaas et al.”), issued Sep. 5, 2006, the entirety of which is hereby incorporated by reference. Thus, in order to avoid redundancy, only those aspects of the inventive cleaning system 300 that differ from the Lauerhaas system will be discussed in detail with respect to schematic representations.

The system 300 comprises a rotary support 322, in the form of a spin chuck. The rotary support supports a wafer 310 to be processed in a substantially horizontal orientation. The rotary support 322 can rotate the wafer 310 about an axis of rotation A-A at any desired speed (i.e., RPM). The system 300 also comprises a process bowl 314, a splash guard 312 and an air deflector 318a. While only one side of the process bowl 314, splash guard 312 and air deflector 318a is illustrated, the process bowl 314, splash guard 312 and air deflector 318a circumferentially surround the axis of rotation A-A.

The process bowl 314 forms a wall-like structure about the rotary support 322, thereby forming an internal volume in which the substrate 310 can be processed. The process bowl 314 comprises and inner surface 350 and an outer surface 351. The process bowl 314 is positioned relative to the rotary supports 322 so that the top edge 352 of the process bowl 314 is located above a top surface of a substrate 310 on the rotary support 322 and the bottom edge 353 of the process bowl 314 is located substantially below a substrate 310 on the rotary support 322.

While the process bowl 314 has generally circular horizontal cross sectional profile, the process bowl 314 can take on a wide variety of shapes. Additionally, while the inner surface 350 of the process bowl 314 is a substantially vertical surface, the inner surface could be angled, sloped or tilted.

The splash guard 312 comprises an inner surface 360 and an outer surface 361. The splash guard 312 is located between the process bowl 314 and the rotary support 322. More specifically, the splash guard 312 is located at a position between an edge of a substrate 310 loaded on the support chuck and the process bowl 314. The splash guard 312 is spaced from the process bowl 314 so that an annular gap 370 exists between the outer surface 312 of the splash guard and the inner surface 350 of the process bowl 314. While the annular gap 370 is a circular gap due to the circular and concentric nature of the process bowl 315 and the splash guard 312 in the illustrated embodiments, the annular gap 370 can be any shape and have varying width, etc.

The splash guard 322 can be moved vertically up and down between a retracted position and a processing position. As used herein vertical movement includes mere tilting of one side of the process bowl 312. When in the processing position, the splash guard 312 is at an elevation and orientation that results in inner surface 360 of the splash guard 312 surrounding the entire edge of the substrate 310 on the rotary support 322. As a result, chemicals/liquids flung off the edge of the rotating substrate 10 contact the inner surface 360 of the splash guard and are directed downward and away from the axis of rotation A-A. When the splash guard 312 is in the retracted position, the substrate 10 can loaded and unloaded from the rotary support 322 without obstruction.

As with the process bowl 314, the splash guard 312 can take on a wide variety of embodiments (as can be seen from the two different structures illustrated in FIGS. 7A and 8), none of which are limiting to the present invention. In FIG. 7A, the splash guard 312 is arc shaped so as to effectively assist in preventing contamination. In FIG. 8, the splash guard 312 has interconnected horizontal, sloped and vertical sections. However, it is to be understood that the shape of splash guard 312 may take other shapes and forms depending upon the overall structure of the cleaning system 300.

Referring still to FIGS. 7A and 8, the system 300 further comprises an edge seal 316 connected to the inner surface of the process bowl 314. The edge seal 316 is a ring-like structure that surrounds the entire inner surface 350 of the process bowl 314. The edge seal 316 in this embodiment does not contact the outer surface of the process bowl 312 (in neither of its processing or retracted positions). However, the edge seal 316 does reduce the size of the annular gap 370 through which droplets can be travel upward.

While the edge seal 316 reduces the size of the annular space 370, a passageway through the gap 370 still exists. The space between the edge seal 316 and the process bowl 312 may be desired in some embodiments so that the splash guard has room to move up and down freely. If this free space is too small, the splash guard 312 will not be able to be lifted up to reach a high level sensor that senses when the splash guard is in the proper processing position. Such an inability to reach the high level sensor will cause the system 300 to stop. However, if this space is too big, the splashed residues will easily fly upward past the edge seal 316. The size of the space between the edge seal 316 and the process bowl 32 may be adjusted for different chambers as needed.

However, so long as a linear unobstructed passageway exists through the annular gap 370, a potential risk of substrate contamination will exist. As discussed in the background section of this application, prior art systems allowed droplets of liquid to travel upward in an unimpeded manner through the gap existing between the process bowl and the splash guard. Due to air flow and other variables, these droplets were then depositing back onto and contaminating the substrate. The inventive system 300 eliminates this problem by utilizing an air deflector. Generally speaking, the air deflector can be any structure or material that prohibits droplets of liquid from traveling upward through the gap 370 and reaching the substrate 10.

In the illustrated embodiment of FIGS. 7A and 8, the air deflector 318a is curtain-like material, such as a clean room wipe, that extends from the process bowl 314 to the outer surface 361 of the splash guard 312. Any means of connected can be used, including adhesion, binding, clamping, etc. In some embodiments, the air deflector 318a may merely rest on the process bowl 314 and the splash guard 312. The air deflector 318a can circumferentially surround the axis of rotation A-A and connect to the process bowl 314 and splash guard 312 along the entire length of the two. As a result, the air deflector 318a will substantially enclose the top of the entire annular gap 370. As illustrated in FIG. 8, the air deflector 318a will prohibit droplets of liquid from leaving the annular gap 370, flying over the splash guard 312 and landing on the substrate 310. The embodiment of the air deflector 318a is preferably made of a flexible clean room compatible material, such as clean room wipes. However, other materials can be used, such as plastics, fabrics, foils, etc.

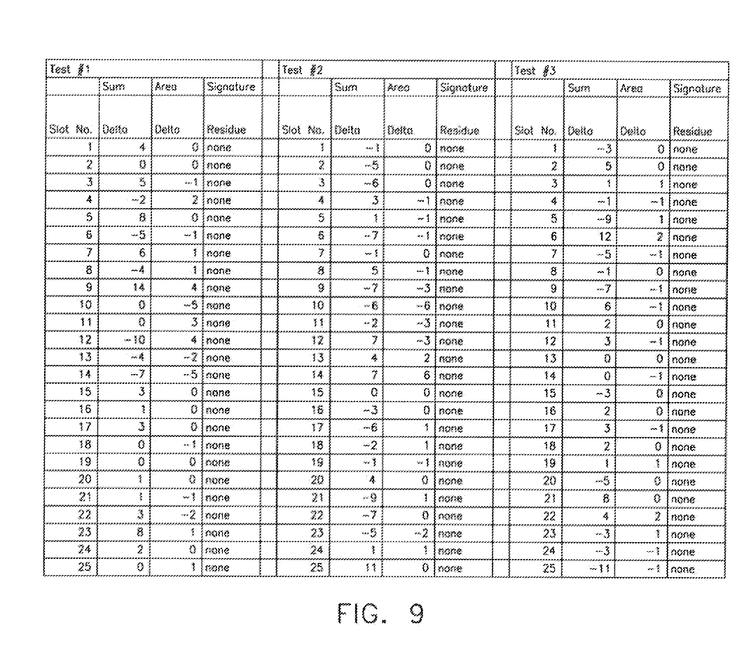

Thus, the sealing of the annular gap 370 effectively prevents the deposit of residue material on substrate 310. FIG. 9 shows a table that presents the results that occurred after cleaning 75 substrates while using wipe deflector 318a, shown in FIG. 7A. As shown in the results there were no contaminated substrates.

FIG. 7B a second embodiment of a system 300A that eliminates residue contamination. In system 300A, the sealing of the annular gap 370A is accomplished by ensuring that the edge seal 316A is in contact with the outer surface 361A of the plash guard 312A, thereby forming a unified integral barrier. This can be done by increasing the size of the edge seal 316A and/or the size and/or shape of the process bowl 312A.

FIG. 7C is a third embodiment of a system 300B that eliminates residue contamination. The system 300B utilizes the air deflector 318a discussed above with respect to FIGS. 7A and 8. However, an edge seal 316 is not present and wipe seal 318a.

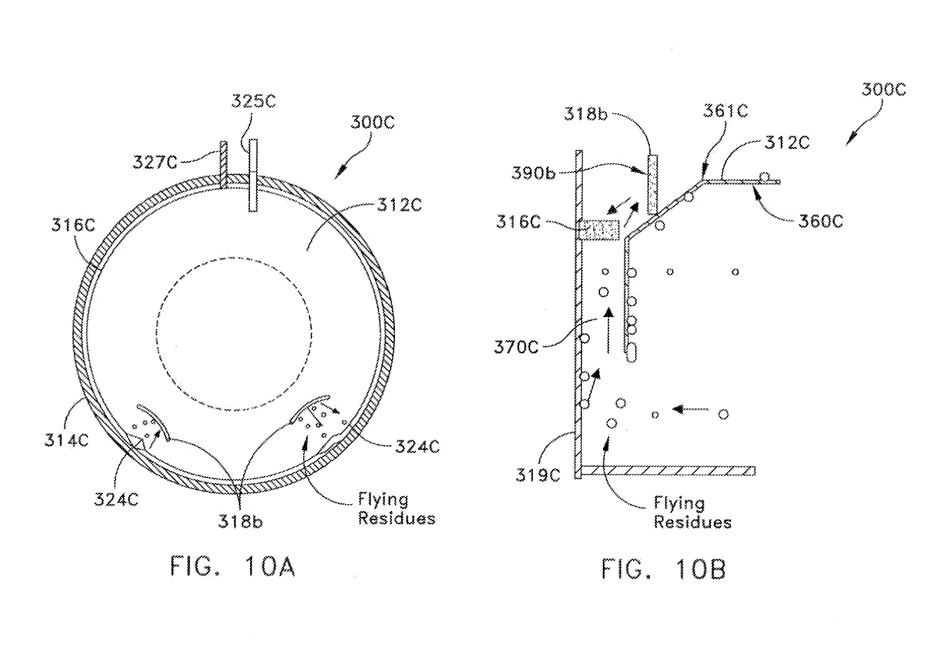

Referring now to FIGS. 10A and 10B concurrently, a fourth embodiment of a system 300C that eliminates residue contamination is schematically illustrated. In system 300C, the edge seal 316C is modified to make the annular gap 370C smaller. The thickness of the edge seal 316C can be increased in any ways, including using an entirely new seal, building up the old one, etc.

The system 300C also includes two air deflectors 318b to block the holes 324 and to prevent any residue material that may escape from the annular gap 370C from being deposited on substrate 310C. FIG. 10A shows a top view of the air deflector 318b blocking the residue material that escapes from the holes 324C. Also shown in FIG. 10A is a megasonic rod 325C, which is used for transmitting sonic energy to the cleaning fluid. A drying apparatus 327C is also present.

As can be seen in FIG. 10B, the air deflector 318b extends upward from the outer surface 316C of the splash guard 312C. The air deflector 318b has an outer surface 390b that is substantially vertical. The air deflector 318B is sufficiently close to the outer perimeter of the splash guard 312C and the gap 370C so that air (which holds droplets) escaping upward through the gap 370C is deflected sufficiently outward from the axis of rotation A-A that any droplets contained in the air do not make it to the substrate 310C on the rotary support 322C, while the outer surface 390b of the air deflector 318b is vertical, in other embodiments, the outer surface 390b may be sloped upward from the outer surface 361C of the splash guard 312c and away from the axis of rotation A-A.

The air deflector 318b is roughly two inches in length and ¾ height, i.e. 5 layers and is made of gasket tape. The air deflector 318b may be between ½ inch and 5 inches in length and ⅛ of an inch and 1 and ½ inch in height depending upon the size of the gap 370C that needs to be closed. The air deflector 318b is made of gasket tape. Gasket tape is a flat, thin, form-in-place gasketing material. This tape can be used to form a full-face, strip-type gasket measuring less than two inches (50.8 mm) in width, for smooth, flat, rectangular sealing surfaces or for narrow sealing surfaces tape under the edge seal and shaving the outside surface smoother.

The air deflector 318b can be extended along the outer surface 361C of the process bowl 312C so as to circumferentially surround the axis of rotation A-A. This will help block any residue droplets that may escape from the gap 370C in the failed chambers.

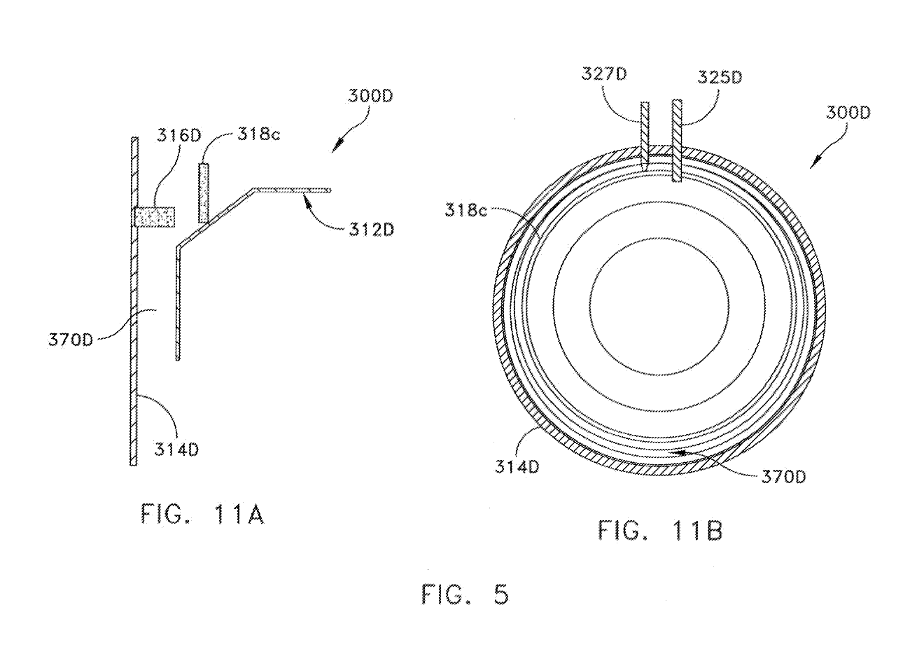

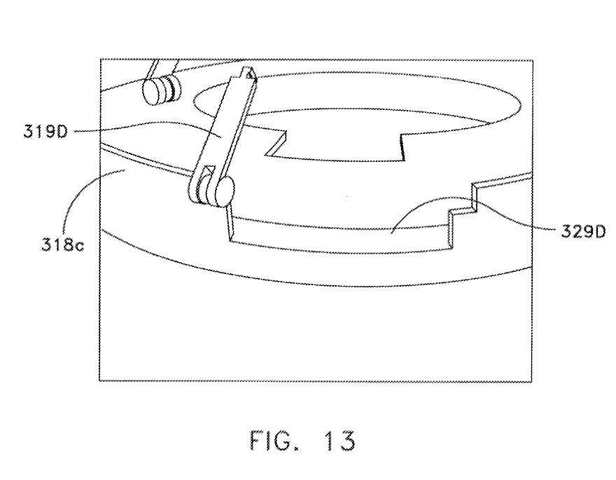

Referring now to FIGS. 11A-13 concurrently, another embodiment of an inventive system 300D is shown. In this system, an air deflector 318a is used to prevent the deposit of residue upon the substrate. The air deflector 318c performs in the same manner as the air deflectors 318b, however it constructed of a more durable plastic material and extends around the entirety of the splash guard 312D. Air deflector 318c is made with HDPE (high density poly ethanol) and is preferably between 1^{1/4}″ height and ⅛″ width around. The air deflector 318c may be between ½″-3″ in height and 1/32″-1″ in width and is located adjacent the inside edge seal 316D and on the splash guard 312D. Most of the material that can be splashed back from the interior wall of housing 314D is prevented by using deflector 318c. As can be seen, only a non-linear passageway exists through the gap 370D from below to above the splash guard 312D.

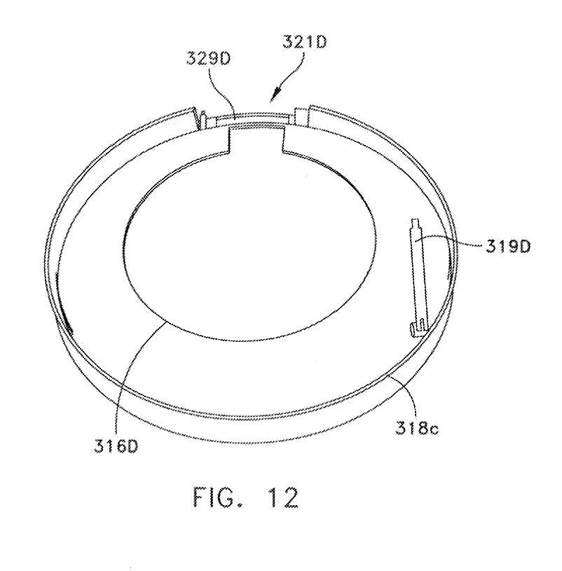

An opening 321D, shown in FIG. 12, is provided in order to permit the passage of a megasonic rod 325D and/or other items. The rear portion 329D of the air deflector 318c has a height of 10 mm and is located at opening 321D, it acts to prevent splash-back as well as to permit the passage of the megasonic rod. Hanger 319D permits the lifting of splash guard 312D.

The usage of deflector 318c effectively prevents any material from being splashed back upon substrate 310D. Deflector 318c effectively prevents any material from being splashed back upon substrate 310D. Deflector 318c prevents a majority of all splash-back situations. However there are additional causes of splash-back that may result in material contaminating substrate 310.

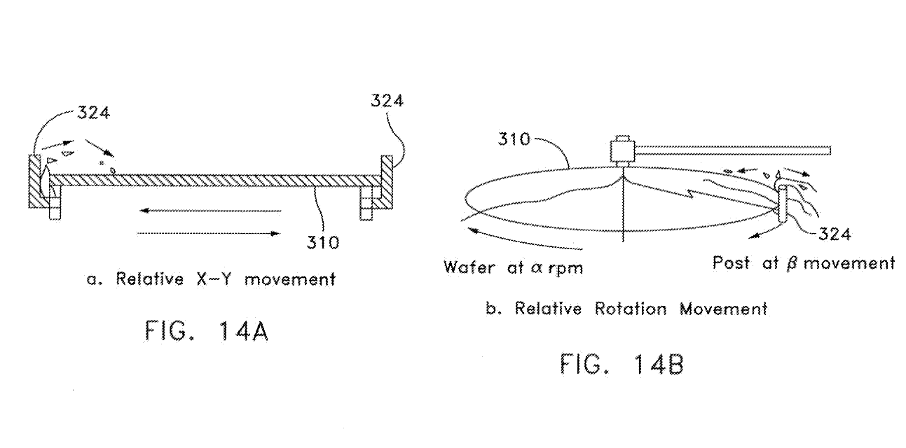

Splash=back also occurred on posts 326 on spinning chuck 322. FIGS. 14A and 14B shows a schematic of two different scenarios that may cause splashing back of material. Splash-back can be crated in two following scenarios 1) splash-back from posts 324 can be caused from the X-Y slipping of substrate 310 and 2) splash-back from posts 324 may also be caused by relative rotational slipping of substrate 310. Both happen simultaneously if substrate 310 slips on the O-rings on spinning chuck 322. It can be determined if the slipping of substrate 310 is occurring by checking the orientation of the notch on substrate 310 before and after cleaning on chuck 322. This splash-back may cause big spots of residue deposited on the edge of substrate 310. IPA wipes may be used to clean the O-rings. This can prevent this type of splash-back by preventing slipping of substrate 310 caused by the O-rings.

Splash-back also occurs on the interior wall of splash guard 312. A spun-off droplet easily crashes itself on the wall, thereby resulting in splash-back. This type of splash-back, however, does not occur often. The reasons why the splash-back infrequently occurs in this production scenario are as follows: 1) substrate 310 is already dried after the Sahara drying, before the high speed spinning takes place, therefore, there are not many residue droplets spun-off from substrate 310 in order to create the splash-back during the high speed spinning of the last step in the recipe; 2) some small splashed back droplets on the guard could not reach substrate 310, if the splash happens on the guard, because of the large distance between splash guard 312 and the wafer edge in the 200 mm Mach2 HP chamber; and 3) high air pressure created by spinning produces downward pressure thereby preventing the splashing droplets from flying up to the wafer.

In making the three mechanisms by which splash-back may contaminate substrate 310, roughly 80% of the splash-back residues are created by having the splash-back takes occur on housing 314 and having residue droplets fly out from the gap located near edge seal 316. 15% of the residues are created by having the residue splashed back on posts 326 and is caused by slippage due to the O-ring. Roughly 5% is created by having the residues splashed back from the splash guard. Although a majority of any potential splash-back can be prevented by using deflector's 318a-318c, there are additional steps that may be taken in order to insure that almost all of the splash-back is avoided. For example, in order to solve the residue problem in SilTerra in the future the following procedure may be as follows 1). Do a regular PM; 2) Check if substrate 310 slipping happens on chuck 322. If yes, use an IPA wipe to clean the O-rings; 3). Modify edge seal 316 in order to minimize the gaps 4). Install deflector 318c. In following these procedural steps (zero residue out of 75 wafers) with a 95% confident level may be achieved.

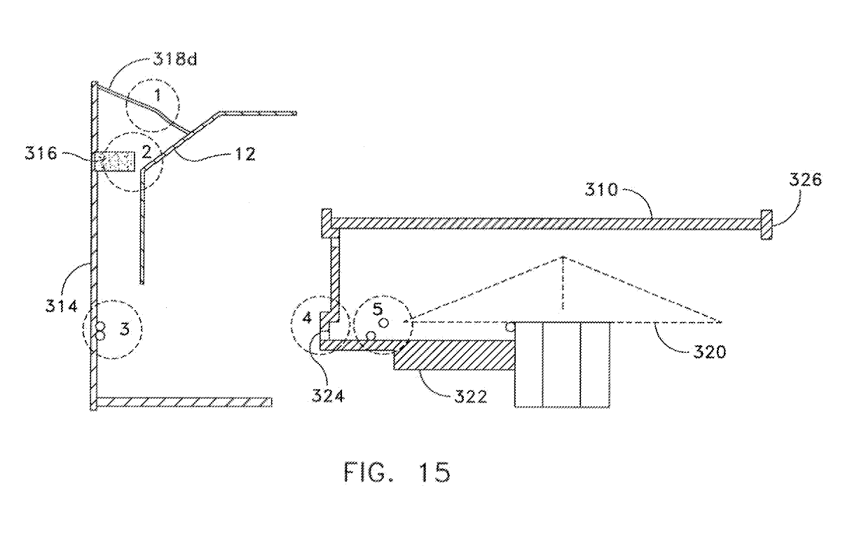

FIG. 15 is a schematic of the system that points to areas where additional improvements further prevent the deposition of sulfur material. As discussed above the gap may be sealed completely as illustrated at area 1 in FIG. 15. The gap between the housing 314 and the splash guard 312 may be covered with a soft certain deflector 318d that does not resist the up-down movements of splash guard 312, or as discussed above any of the embodiment 318a-318c. The curtain deflector 318d functions well and may be made out of plastic-type material.

At area 2, the opening between edge seal 316 and splash guard 316 may be sealed, such as shown in FIG. 7B. The current edge seal works fine with 1200 rpm of spinning, but it has a residue problem when spun at 1800 rpm. Therefore, there is not much room to shorten the recipe time. The total recipe time is 150 seconds and the DSP cleaning tape takes only 40 seconds. It is believed that the recipe time can be reduced if it does not have the residue problem at higher spin speed.

Alternatively at area 3 the amount of liquid droplets can be reduced on the wall of housing 314. The more droplets that hang on the wall, the more of a chance of creating back splash droplets. The number of droplets that accumulate can be reduced by applying a hydrophilic surface to process housing 314. The amount of droplets can also be reduced by applying longer DI water rinsing.

Another method for reducing the droplets is to close holes 324. Holes 324 are located on the spin chuck 322. Holes 324 are where the paths of droplets flying out of the chuck 322 go. Sealing holes 324 will reduce the amount of flying droplets.

Residue can also be avoided by reducing the liquid droplets on chuck 322 and backside nozzle 320. Wiping out the droplets can eliminate the sulfur residue. The intermediate high speed spinning in the recipe also assists in accomplishing this purpose. Each of the above mentioned methods may be applied separately or together in order to accomplish the reduction of residue.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A system for processing a substrate comprising:
a rotary support for supporting a substrate in a substantially horizontal orientation, the rotary support adapted to rotate about an axis of rotation;
a wall structure circumferentially surrounding the rotary support about the axis of rotation, the wall structure extending above and below a top surface of a substrate positioned on the rotary support;
a splash guard circumferentially surrounding the rotary support about the axis of rotation, the splash guard positioned between the rotary support and the wall structure so that an annular gap exists between an outer surface of the splash guard and an inner surface of the wall structure;
means for moving the splash guard between a processing position and a retracted position; and
a member extending from the wall structure to the outer surface of the splash guard when the splash guard is in the processing position, the member adapted to allow unimpeded movement of the splash guard between the retracted position and the process position.

2. The system of claim 1 wherein the member is a curtain.

3. The system of claim 1 wherein when the splash guard is in the processing position, the splash guard extends above and below a top surface of a substrate positioned on the rotary support.

4. The system of claim 3 wherein when the splash guard is in the retracted position, at least a portion of the splash guard is entirely below the rotary support so that a substrate can be loaded onto and/or unloaded from the rotary support.

5. The system of claim 1 wherein the splash guard has an inner surface that is curved or angled downward and away from the axis of rotation.

6. The system of claim 1 further comprising a dispenser for dispensing a liquid to a surface of a substrate positioned on the rotary support.

7. The system of claim 1 wherein the member is constructed of a flexible material.

8. The system of claim 1 wherein the member substantially encloses the entire annular gap.

9. The system of claim 1 wherein the annular gap is circular in shape.

10. The system of claim 1 wherein the member is a wipe deflector or a curtain deflector.

11. A system for processing a substrate comprising:
a rotary support for supporting a substrate in a substantially horizontal orientation, the rotary support adapted to rotate about an axis of rotation;
a wall structure circumferentially surrounding the rotary support about the axis of rotation, the wall structure extending above and below a top surface of a substrate positioned on the rotary support;
a splash guard circumferentially surrounding the rotary support about the axis of rotation, the splash guard positioned between the rotary support and the wall structure so that an annular gap exists between an outer surface of the splash guard and an inner surface of the wall structure;
means for vertically moving the splash guard between a processing position and a retracted position;
an edge seal connected to the inner surface of the wall structure; and
wherein when the splash guard is in the processing position, the edge seal contacts an outer surface of the splash guard thereby substantially enclosing the gap.

12. A system for processing a substrate comprising:
a rotary support for supporting a substrate in a substantially horizontal orientation, the rotary support adapted to rotate about an axis of rotation;
a wall circumferentially surrounding the rotary support about the axis of rotation, the wall extending above and below a top surface of a substrate positioned on the rotary support;
a splash guard circumferentially surrounding the rotary support about the axis of rotation, the splash guard positioned between the rotary support and the wall so that an annular gap exists between an outer surface of the splash guard and an inner surface of the wall structure;
a structure extending upward from the outer surface of the splash guard, the structure adapted to prohibit droplets carried upward through the gap by air flow from depositing on a substrate on the rotary support.

13. The system of claim 12 wherein the structure extends upward along the outer surface of the splash guard so as to circumferentially surround the axis of rotation.

14. The system of claim 12 further comprising an edge seal connected to the inner surface of the wall, the edge seal reducing the size of the annular gap.

15. The system of claim 12 further comprising means for vertically moving the splash guard between a processing position and a retracted position.

16. The system of claim 12 wherein the structure comprises an outer surface that extends substantially vertically upward from the outer surface of the splash guard.

17. The system of claim 12 wherein the structure comprises an outer surface that extends upward from the outer surface of the splash guard and away from the axis of rotation.

18. The system of claim 12 wherein the structure is a ring-like structure.

19. The system of claim 12 further comprising:
an edge seal connected to the inner surface of the wall, the edge seal reducing the size of the annular gap.
means for vertically moving the splash guard between a processing position and a retracted position, wherein when the splash guard is in the processing position, the edge seal does not contact the splash guard; and
wherein the structure is a ring-like structure comprising an outer surface that extends substantially vertically upward from the outer surface of the splash guard.

20. The system of claim 12 further comprising transducer assembly for applying megasonic energy to a substrate positioned on the rotary support.

21. The system of claim 20 further comprising:
the transducer assembly comprising a transmitter and a transducer acoustically coupled to the transmitter; and
a cutout in the wall for extending the transmitter into and out of a volume surrounded by the wall.

22. The system of claim 12 wherein the splash guard comprises a vertical wall portion, an sloped wall portion and a horizontal wall portion, the sloped wall portion connected to a top edge of the vertical wall portion and to an outer edge of the horizontal wall portion, the sloped wall portion inclined downward and away from the axis of rotation.

23. The system of claim 22 wherein the structure extends upward from the outer surface of the sloped wall portion of the splash guard.

24. The system of claim 23 further comprising:
an edge seal connected to the inner surface of the wall, the edge seal reducing the size of the annular gap;
means for vertically moving the splash guard between a processing position and a retracted position, wherein when the splash guard is in the processing position, the edge seal does not contact the splash guard and is adjacent the sloped surface of the splash guard.

25. The system of claim 12 further comprising a edge seal connected to the inner surface of the wall, the edge seal reducing the size of the annular gap; and wherein a linear path does not exist through the gap from a position below the splash guard to a position above the structure.

26. The system of claim 12, wherein said structure is a type deflector.

27. The system of claim 12 wherein said first deflector is made of a high density polymer.
